(19) United States
(12) Patent Application Publication
(10) Pub. No.: US 2025/0014805 A1
(43) Pub. Date: Jan. 9, 2025

(54) MULTI-HELICAL WINDINGS FOR A TRANSFORMER

(71) Applicant: Hitachi Energy Ltd, Zürich (CH)

(72) Inventor: Ion RADU, Raleigh, NC (US)

(21) Appl. No.: 18/711,290

(22) PCT Filed: Nov. 18, 2021
(86) PCT No.: PCT/EP2021/082211

§ 371 Date: May 17, 2024

(51) Int. Cl. H01F 27/28; H01F 27/29; H01F 27/32; H01F 30/06

(52) U.S. Cl. CPC H01F 27/2823; H01F 27/2876; H01F 27/324; H01F 30/06; H01F 27/29

(57) ABSTRACT

Multi-helical windings in a transformer are disclosed. A group of helical windings (100) that are connected in series (e.g., a single, continuous cable wound around a cylinder) may be concentrically arranged around a longitudinal axis to induce magnetic flux in the same direction along the longitudinal axis. A plurality of such groups (100) may be connected in series and arranged radially around the longitudinal axis. Additionally or alternatively, a pair of groups may be connected in parallel and arranged at the same radial distance around the longitudinal axis with an axial separation between the pair. In addition, spaces (DI) may be formed radially between the turns (112A-N) of the helical windings (110A-D) and axially on radial ends of the group for cooling. The disclosed configurations may be used as the LV or HV winding in any type of transformer, including single-phase and three-phase distribution, dry, and power transformers.

### CROSS REFERENCE TO RELATED APPLICATIONS

This application is a 35 U.S.C. § 371 national stage application of PCT International Application No. PCT/EP2021/082211 filed on Nov. 18, 2021, the disclosure and content of which is incorporated by reference herein in its entirety.

### TECHNICAL FIELD

The embodiments described herein are generally directed to transformers, and, more particularly, to windings used in transformers.

### BACKGROUND

In general, a transformer comprises a core and at least two windings of conductive coil around one or more portions of the core. A varying current through a primary one of the two windings induces magnetic flux in the core, which in turn, induces a varying electromotive force in the secondary winding. In a step-up transformer, the primary winding is a low voltage (LV) winding, and the secondary winding is a high voltage (HV) winding. In a step-down transformer, the primary winding is an HV winding, and the secondary winding is an LV winding. This general configuration is common to all types of transformers, including, for example, distribution transformers, dry transformers, and power transformers.

The configuration of the windings in a transformer can negatively affect the dimensions and performance of the transformer, including the size, rated power, permissible current and voltage, internal temperatures, and/or the like. The present disclosure is directed toward overcoming one or more of the problems in transformer winding configurations.

### SUMMARY

Embodiments are disclosed for configuring one or both of the LV and HV windings in any type of transformer to achieve, for example, one or more of the advantages described herein.

In an embodiment, an apparatus is disclosed that comprises: a group of helical windings configured to be concentrically arranged around a transformer core and concentrically arranged around a longitudinal axis to induce magnetic flux in a same direction along the longitudinal axis; and at least one helical winding in the group is conductively connected in series to an adjacent helical winding and has a different inner radial distance from the longitudinal axis than the adjacent helical winding.

The apparatus may comprise two groups of helical windings, wherein a first one of the two groups is connected in parallel with a second one of the two groups, the first group and the second group have a same inner radial distance from the longitudinal axis, and the first group is separated from the second group by an axial distance in an axial direction that is parallel to the longitudinal axis. The second group may mirror the first group across a radial axis that is orthogonal to the longitudinal axis and bisects the axial distance.

The apparatus may comprise a plurality of groups of helical windings, wherein the plurality of groups are concentric to each other around the longitudinal axis, and at least one of the plurality of groups is conductively connected in series to an adjacent one of the plurality of groups, and has a different inner radial distance from the longitudinal axis than the adjacent group.

In an embodiment, a transformer is disclosed that comprises: a core; a first group of helical windings; and a second group of helical windings that is connected in parallel with the first group, wherein each of the first group and the second group encircles the core, is concentrically arranged around a longitudinal axis of the core to induce magnetic flux in the core, and has a same inner radial distance from the longitudinal axis, the first group is separated from the second group by an axial distance in an axial direction that is parallel to the longitudinal axis, and within each of the first group and the second group, at least one helical winding in the group is conductively connected in series to an adjacent helical winding in the group, and has a different inner radial distance from the longitudinal axis than the adjacent helical winding. The second group may mirror the first group across a radial axis that is orthogonal to the longitudinal axis and bisects the axial distance.

In an embodiment, a transformer is disclosed that comprises: a core; and a first plurality of groups of helical windings, wherein each of the first plurality of groups encircles the core, is concentrically arranged around a longitudinal axis of the core to induce magnetic flux in the core in a same direction along the longitudinal axis, and has a different inner radial distance from the longitudinal axis than any other one of the first plurality of groups, within at least one of the first plurality of groups, at least one of a plurality of turns in each of the helical windings of the at least one group is spaced apart from an axially adjacent turn, to form at least one radially extending space through all of the helical windings in the at least one group in a radial direction that is orthogonal to the longitudinal axis, and, for at least one adjacent pair of the first plurality of groups, comprising an inner group and an outer group, an outermost one of the helical windings in the inner group is spaced apart from an innermost one of the helical windings in the outer group in the radial direction, to form one or more axially extending spaces between the outermost helical winding in the inner group and the innermost helical winding in the outer group. The transformer may further comprise: a second plurality of groups of helical windings that is connected in parallel with the first plurality of groups, wherein each of the second plurality of groups encircles the core, is concentrically arranged around the longitudinal axis to induce magnetic flux in the core in a same direction along the longitudinal axis, and has a different inner radial distance from the longitudinal axis than any other one of the second plurality of groups, the first plurality of groups and the second plurality of groups have a same inner radial distance from the longitudinal axis, the first plurality of groups is separated from the second plurality of groups by an axial distance in an axial direction that is parallel to the longitudinal axis, and the second plurality of groups mirrors the first plurality of groups across a radial axis that is orthogonal to the longitudinal axis and bisects the axial distance.

### BRIEF DESCRIPTION OF THE DRAWINGS

The details of the present disclosure, both as to its structure and operation, may be gleaned in part by study of the accompanying drawings, in which like reference numerals refer to like parts, and in which:

FIG. 1 illustrates an exploded side view of a single group of helical windings, according to an embodiment;

FIG. 2 illustrates a side profile view of a single group of helical windings, according to an embodiment;

FIG. 3 illustrates cross-sectional views of a single group of helical windings, substantially down the longitudinal axis, according to alternative embodiments;

FIG. 4 illustrates a cross-sectional view of half of a single group of helical windings, in a cross-sectional plane that contains the longitudinal axis, according to an embodiment;

FIG. 5 illustrates a plurality of concentrically arranged groups with even numbers of helical windings (number of groups may be even or odd, and connections between groups may all be on a single end), according to an embodiment;

FIG. 6 illustrates a plurality of concentrically arranged groups with odd numbers of helical windings (number of groups may be even or odd, and connections between groups may alternate between ends), according to an embodiment;

FIG. 7 illustrates an exploded side view of an axially separated pair of groups of helical windings, according to an embodiment;

FIG. 8 illustrates a side profile view of an axially separated pair of groups of helical windings, according to an embodiment;

FIG. 9 illustrates a cross-sectional view of half of an axially separated pair of groups of helical windings, according to an embodiment;

FIG. 10 illustrates a cross-sectional view of half of axially separates pluralities of radially arranged groups of helical windings, in a cross-sectional plane that contains the longitudinal axis, according to an embodiment;

FIG. 11 illustrates a perspective view of a limb of a transformer core encircled by a single group of helical windings, according to an embodiment;

FIG. 12 illustrates cross-sectional profiles of groups of helical windings, in a cross-sectional plane that is substantially orthogonal to the longitudinal axis, according to various embodiments;

FIG. 13 illustrates a single-phase transformer core, according to various embodiments;

FIG. 14 illustrates a three-phase transformer core, according to various embodiments;

FIG. 15 illustrates a perspective view of a transformer core, according to an embodiment, according to an embodiment; and

FIG. 16 illustrates a cross-sectional profile view of a plurality of windings around a limb of a transformer core, in a cross-sectional plane that contains the longitudinal axis, according to two embodiments.

### DETAILED DESCRIPTION

Embodiments of a winding configuration for a transformer are described herein. Any embodiment of the described winding configuration may be applied to any type of transformer, including, without limitation, distribution transformers, dry transformers, and power transformers. In addition, any embodiment of the described winding configuration may be used as one or both of the LV winding and the HV winding in the transformer. For example, a transformer may utilize any disclosed embodiment as only the LV winding in a transformer, only the HV winding in a transformer, or both the LV winding and the HV winding in a transformer. If disclosed embodiments are used for both the LV winding and the HV winding in the same transformer, the same embodiment may be used for both the LV winding and the HV winding, or a different embodiment may be used for the LV winding than for the HV winding.

After reading this disclosure, it will become apparent to one skilled in the art how to implement the various alternative embodiments and alternative applications described herein. However, although various embodiments will be described herein, it is understood that these embodiments are presented by way of example and illustration only, and not limitation. As such, this detailed description of various embodiments should not be construed to limit the scope or breadth of the present disclosure as set forth in the appended claims.

### 1. Group of Helical Windings

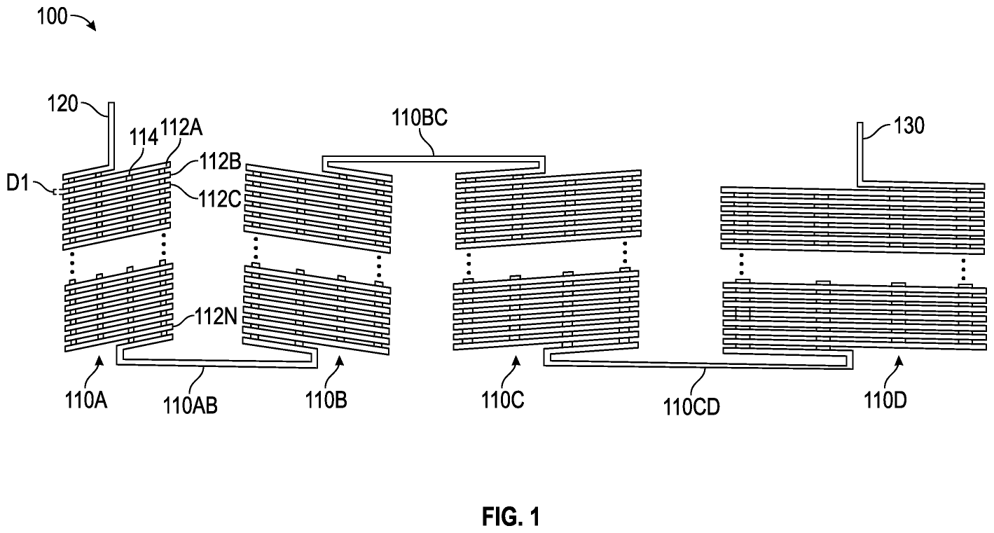

FIG. 1 illustrates an exploded side view of a single group of helical windings, according to an embodiment. In particular, each group 100 comprises a plurality of helical windings 110. In the illustrated example, group 100 comprises four helical windings 110A, 110B, 110C, and 110D. However, it should be understood that a group 100 may comprise any plurality of helical windings 110, including two helical windings 110, three helical windings 110, four helical windings 110, five helical windings 110, and so on and so forth.

Each helical winding 110 comprises a cable (e.g., comprising insulated conductive wire) arranged helically around a longitudinal axis. A single continuous cable (i.e., without any cuts) may be used for all helical windings 110 in a group 100. For the purposes of illustrating each helical winding 110, FIG. 1 depicts helical windings 110 in separated stacks. In reality, it should be understood that helical windings 110 would be nested within each other, for example, with helical winding 110A nested within helical winding 110B, helical winding 110B nested within helical winding 110C, and helical winding 110C nested within helical winding 110D.

Each helical winding 110 comprises a plurality of turns 112. For example, helical winding 110 comprises turns 112A, 112B, 112C, . . . , 112N. All helical windings 110 in the same group 100 may consist of the same number of turns 112. For example, each of helical windings 110A-110D may consist of the same number of turns 112. However, it is not necessary that all of helical windings 110 in group 100 consist of the same number of turns 112. The number of turns 112 may, instead, vary between helical windings 110 in group 100, depending on the desired voltage. For example, one or more helical windings 110 in the same group 100 may consist of a different number of turns 112 than one or more other helical windings 110 in that group 100.

Each turn 112 in a helical winding 110 may be separated from each axially adjacent turn by a non-zero axial distance. For example, turn 112B is separated from axially adjacent turn 112A on one axial side by an axial distance D1. In addition, turn 112B is separated from axially adjacent turn 112C on the other axial side by the same axial distance D1. The axial distance D1 between turns 112 may be implemented by incorporating spacers 114 between turns 112. For example, spacers 114 may be provided (e.g., fixed during manufacture of the cable or placed after manufacture of the cable) at equidistant intervals along the cable before or as helical windings 110 are wound around a cylinder. Alternatively, spacers 114 may be placed in a different manner or the axial distance D1 may be implemented in a different manner. It should be understood that while it is generally contemplated that each turn 112 would be separated from each adjacent turn 112 in the same helical winding 110 by the same axial distance D1, this is not a requirement of any embodiment. Rather, some or all adjacent turns 112 may have no separation at all in the axial direction (i.e., D1=0), or the axial distances between some or all adjacent turns 112 may vary throughout a helical winding 110.

Each helical winding 110 in a group 100 is connected in series to each adjacent helical winding 110 in the same group 100. For example, helical winding 110A is connected in series to adjacent helical winding 110B by connection 110AB. In turn, helical winding 110B is connected in series to adjacent helical winding 110C by connection 110BC. Similarly, helical winding 110C is connected in series to adjacent helical winding 110D by connection 110CD. Notably, each internal helical winding 110 (e.g., 110B and 110C) is connected to its adjacent helical windings 110 on opposing ends of group 100. For example, helical winding 110B is connected to radially inward and adjacent helical winding 110A by an inner connection 110AB on a first end of group 100, whereas helical winding 110B is connected to radially outward and adjacent helical winding 110C by an outer connection 110BC on a second and opposing end of group 100. In addition, the ends at which these connections are formed alternate across group 100. For example, helical winding 110C is connected to radially inward and adjacent helical winding 110B by connection 110BC on the second end of group 100, and is connected to radially outward and adjacent helical winding 110D by connection 110CD on the first end of group 100.

In an embodiment, a lead 120 is provided to an inner or innermost helical winding (e.g., 110A), and a lead 130 is provided to an outer or outermost helical winding (e.g., 110D). It should be understood that leads 120 and 130 may comprise the two end portions of the same single continuous cable that forms helical windings 110. When group 100 is installed in a transformer, lead 120 may be conductively connected to an X1 terminal of the transformer. Alternatively, in an embodiment with multiple groups 100, as discussed elsewhere herein, lead 120 of group 100 may be conductively connected to a lead 130 of a radially inward and adjacent group 100. Similarly, lead 130 may be conductively connected to an X2 terminal of a transformer, or, in an embodiment with multiple groups 100, may be conductively connected to a lead 120 of a radially outward and adjacent group 100. Leads 120 and 130 may be positioned on the same end of group 100, and/or the conductively connected X1 and X2 terminals of the transformer may be positioned on a same end of the transformer.

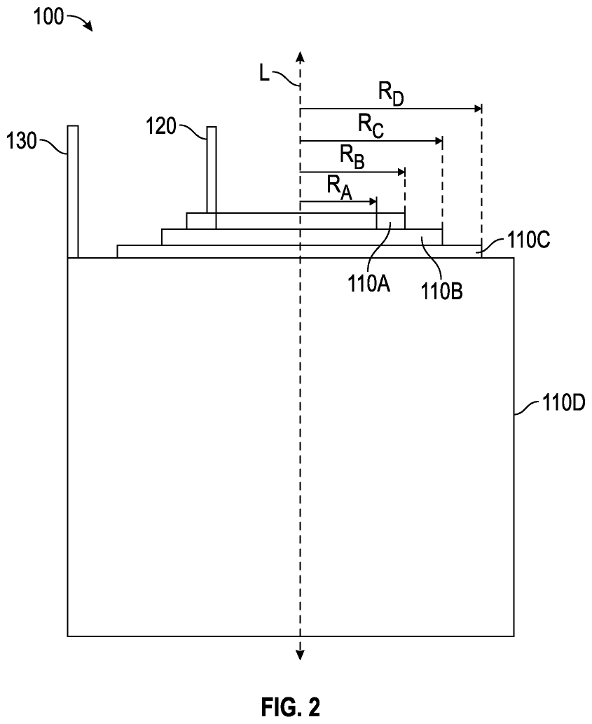

FIG. 2 illustrates a side profile view of a single group 100 of helical windings 110, according to an embodiment. For ease of illustration, the plurality of turns 112 in each helical winding 110 are not individually depicted, as in FIG. 1. Group 100 has a longitudinal axis L extending through the center of group 100. As used throughout, the terms “radius,” “radial,” and “radially,” or variations thereof, refer to an axis or direction that is orthogonal to longitudinal axis L. In addition, the terms “axial” and “axially,” or variations thereof, refer to an axis or direction that is parallel to longitudinal axis L.

In FIG. 2, the height of each helical winding 110, along longitudinal axis L, has been varied to show the nesting or layering of helical windings 110. In the illustrated embodiment, the heights of helical windings 110, along longitudinal axis L, decrease from the innermost helical winding 110 (e.g., 110A being the tallest) to the outermost helical winding 110 (e.g., 110D being the shortest). In an alternative embodiment, the heights of helical windings 110 may increase from the innermost helical winding 110 (e.g., 110A being the shortest) to the outermost helical winding 110 (e.g., 110 being the tallest). Different heights may be used for helical windings 110 in group 100 to, for example, implement different capacities in different helical windings 110 within group 100 and/or to homogenously distribute dielectric stress across group 100. In these cases, the particular heights of windings 110 may be determined by dielectric testing. In an alternative embodiment, the heights of each helical winding 110, along longitudinal axis L, may be identical.

In an embodiment, all helical windings 110 in a group 100 are concentrically arranged around longitudinal axis L and configured to induce magnetic flux in the same direction along longitudinal axis L. Thus, the radius of each helical winding 110, whether defined as the inner radius or the outer radius, differs from the radius of every other helical winding 110 in the same group 100. For example, the inner radius R_{A} of helical winding 110A is less than the inner radius R_{B} of adjacent helical winding 110B, which is less than the inner radius R_{C} of adjacent helical winding 110C, which is less than the inner radius R_{D} of adjacent helical winding 110D.

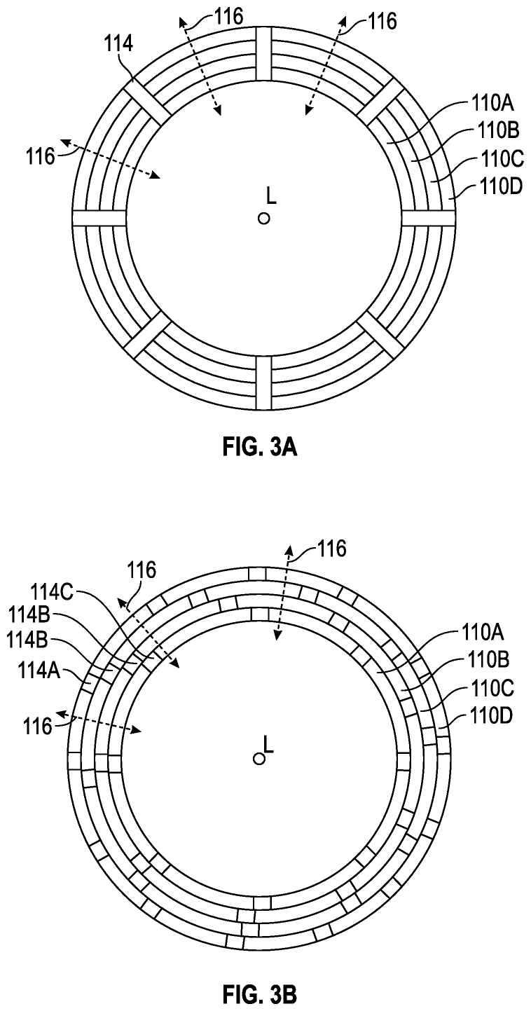

FIG. 3 illustrates cross-sectional views of a single group 100 of helical windings 110 substantially down longitudinal axis L, according to two alternative embodiments. In the illustrated examples, the cross-sectional plane extends between two adjacent turns 112. In embodiments that separate turns 112 to create axial distances D1 between turns 112, there will be at least one radial space 116 through a group 100 of helical windings 110 from the innermost helical winding 110 (e.g., 110A) to the outermost helical winding 110 (e.g., 110D). Each radial space 116 permits coolant to flow between turns 112.

As discussed above, spacers 114 may be used to create and maintain the axial distance D1 between adjacent turns 112. In embodiment (a) in FIG. 3, spacers 114 are radial spacers that extend continuously across group 100 between the innermost helical winding 110 (e.g., 110A) and the outermost helical winding 110 (e.g., 110D). In this case, each helical winding 110 has the same number of spacers 114 and each radial space 116 has a contiguous partial-wedge shape. To implement this embodiment, spacers 114 may be placed as the cable is wound into helical windings 110.

In alternative embodiment (b) in FIG. 3, spacers 114 are placed at equidistant intervals along each helical winding 110, so as to protrude in an axial direction from each turn 112. In this case, spacers 114 will generally not align along a radial axis, since inner helical windings 110 (e.g., 110A) will have shorter circumferences than outer helical windings 110 (e.g., 110B), such that inner helical windings 110 will have fewer spacers 114 than outer helical windings 110. However, regardless of the alignment of spacers 114, multiple radial spaces 116 will be formed through helical windings 110 of group 100. While these radial spaces 116 may be broken up by spacers 114, they will still permit liquid coolant to flow between turns 112 in helical windings 110 of group 100. To implement this embodiment, spacers 114 may be fixed (e.g., adhered) to the cable before it is wound into helical windings 110, or alternatively, may be fixed to the cable as it is wound into helical windings 110.

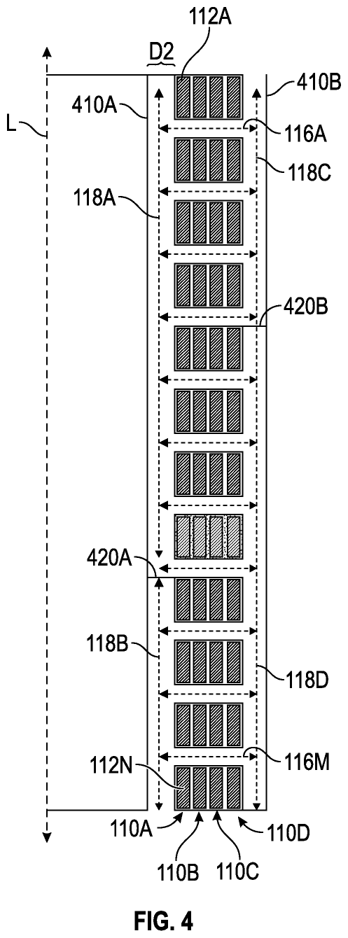

FIG. 4 illustrates a cross-sectional view of half of a single group 100 of helical windings 110, in a cross-sectional plane that contains longitudinal axis L, according to an embodiment. For case of illustration, only a single half of group 100 is shown. It should be understood that, in FIG. 4 and other figures that illustrate only one side of longitudinal axis L, the other half of each group 100 will mirror the illustrated half of that group 100 across longitudinal axis L.

Group 100 may encircle an inner cylinder 410A. Inner cylinder 410A may be configured in shape and diameter to encircle the core of a transformer. Group 100 may also be encircled by an outer cylinder 410B. Each cylinder 410 may comprise or consist of an insulation layer that prevents the conduction of electricity and/or heat through cylinder 410.

In an embodiment, group 100 is separated from each radially adjacent cylinder 410 by a radial distance. For example, the innermost helical winding 110 (e.g., 110A) of group 100 may be separated from radially adjacent inner cylinder 410A by a non-zero radial distance D2. In addition, the outermost helical winding 110 (e.g., 110D) of group 100 may be separated from radially adjacent outer cylinder 410B by the same radial distance D2 or a different radial distance. The radial distance D2 between group 100 and each adjacent cylinder 410 may be implemented by incorporating a plurality of axial spacers (not shown) that extend axially between group 100 and the adjacent cylinder 410. For example, a plurality of axial spacers may be attached to the outside surface of cylinder 410A, extending from end to end of cylinder 410A, parallel to longitudinal axis L. Similarly, a plurality of axial spacers may be attached to the inside surface of cylinder 410B, extending from end to end of cylinder 410B, parallel to longitudinal axis L. For each cylinder 410, the axial spacers may be spaced equidistantly apart around the circumference of cylinder 410.

In embodiments that separate group 100 from each cylinder 410 to create a radial distance D2 between group 100 and cylinder 410, there will be at least one axial space 118 between group 100 and cylinder 410. In an embodiment which comprises both radial space(s) 116 and axial space(s) 118, each radial space 116 may be connect or otherwise be in fluid communication with one or two axial spaces 118, and each axial space 118 may connect or otherwise be in fluid communication with one or a plurality of radial spaces 116. Thus, fluid paths for the flow of coolant are formed through group 100 in both radial and axial directions.

In the illustrated embodiment, each turn 112 in each helical winding 110 is separated by a non-zero axial distance D1 from each axially adjacent turn 112 and is aligned with each radially adjacent turn 112 in each adjacent helical winding 110, to form at least one radial space 116 that extends radially through all helical windings 110 in the same group 100. Thus, if there are N turns 112 (e.g., 112A-112N) in each helical winding 110 (e.g., 110A-110D), there will be at least M=N−1 radial spaces 116 (e.g., 116A-116M) in group 100. As shown, each radial space 116 is connected to both an inner axial space 118 (e.g., 118A or 118B) and an outer axial space 118 (e.g., 118C or 118D).

In an embodiment, one or more liquid guides 420 may be provided to improve the uniformity in coolant flow through group 100. For example, liquid guide 420A extends radially outward from inner cylinder 410A through a radial space 116, thereby dividing inner axial space 118 into two portions 118A and 118B. Similarly, liquid guide 420B extends radially inward from outer cylinder 410B through a different radial space 116, thereby dividing outer axial space 118 into two portions 118C and 118D. By dividing the inner and outer axial spaces 118 in this manner, coolant is forced to flow through radial spaces 116. While only two liquid guides 420 are shown, it should be understood that any number of liquid guides 420 may be provided and that the number of liquid guides 420 that are used may depend upon design goals, the number of turns 112 in each helical winding 110, and/or the like. Each liquid guide 420 may extend continuously around the entire circumference (e.g., radially outward or radially inward) of the respective cylinder 410 or may only partially extend around the circumference of respective cylinder 410 (e.g., at equidistant intervals), such that liquid guide 420 forms a disk or shelf around the circumference of cylinder 410. In an embodiment in which each liquid guide 420 extends through a radial space 116, it should be understood that liquid guide 420 will extend around the circumference of the respective cylinder 410 in substantially the same helical shape as the respective turns 112 defining the axial boundaries of radial space 116. Alternatively, liquid guide 420 may radially extend only through axial space 118, without further radially extending through a radial space 116.

As mentioned above, liquid guides 420 aid in cooling group 100. For example, in the illustrated embodiment, coolant may flow into axial space 118C, radially inward through radial spaces 116, into axial space 118A. Coolant may then flow from axial space 118A, radially outward through radial spaces 116, into axial space 118D. Coolant may then flow from axial space 118D, radially inward through radial spaces 116, into and out of axial space 118B (e.g., to be pumped back up to axial space 118C). In an alternative embodiment, coolant may be pumped in the reverse direction. In either case, radial spaces 116 and axial spaces 118 form ducts for coolant flow. In another alternative embodiment, group 100 may simply be immersed in a coolant without a forced flow. The coolant may comprise any substance that is commonly used to cool windings in a transformer, including, for example, high-temperature hydrocarbons, silicones, esters, air, and the like.

In alternative embodiments, one or more radial spaces 116 and/or one or more axial spaces 118 may be omitted. For example, not every turn 112 in a helical winding 110 must be axially separated from each adjacent turn 112 by a distance D1. Rather, zero, one, or a partial subset of turns 112 may be separated from adjacent turns 112 by a distance D1, while the remaining turns 112 may directly or indirectly abut their adjacent turns 112 without any space in between (i.e., D1=0). Furthermore, turns 112 across adjacent helical windings 110 do not necessarily have to be aligned. In this case, radial spaces 116 may not extend fully through group 100 and may, instead, form non-continuous, disjointed spaces through one or more helical windings 110. In addition, the inner axial space 118 (e.g., 118A and 118B) and/or the outer axial space 118 (e.g., 118C and 118D) may be omitted. If the inner axial space 118 is omitted, the innermost helical winding 110 (e.g., 110A) will directly contact an inner cylinder 410 (e.g., 410A). If the outer axial space 118 is omitted, the outermost helical winding 110 (e.g., 110D) will directly contact an outer cylinder 410 (e.g., 410B).

### 2. Multiple Groups of Helical Windings Radially Arranged

In an embodiment, a plurality of groups 100 of helical windings 110 may be nested within each other, along a radial axis, and conductively connected in series. Each group 100 in the plurality of groups 100 may be arranged concentrically with the other groups 100 in the plurality of groups 100 and be concentric with longitudinal axis L. Any number of groups 100 may be nested in this manner. As mentioned above, the plurality of groups 100 may be used as the LV winding in a transformer or as the HV winding in a transformer. Furthermore, in a given transformer, both the LV winding and the HV winding may comprise a plurality of groups 100 arranged in this manner. It should be understood that each group 100 may be configured as described above, and may be essentially identical to each other, except in terms of their respective radii, which will differ, and those characteristics that relate to their respective radii (e.g., length of cable, number of spacers 114, circumference of liquid guides 420, etc.).

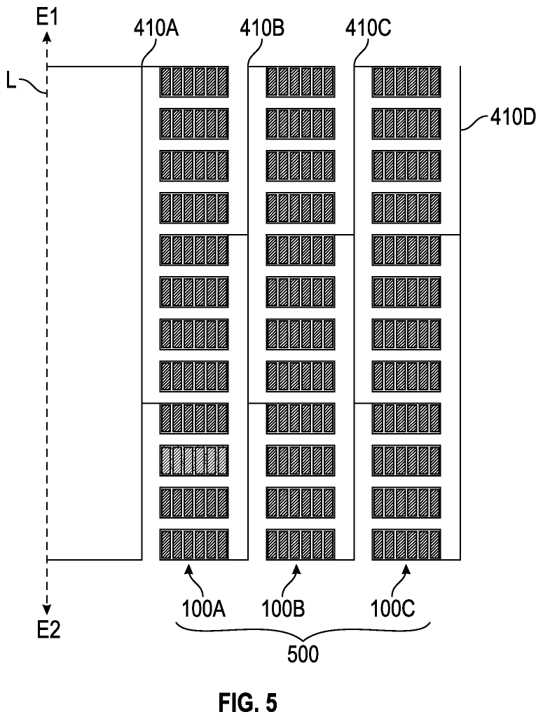

FIG. 5 illustrates a plurality 500 of concentrically arranged groups 100, in which each group 100 comprises an even number of helical windings 110, according to an embodiment. In the illustrated example, each group 100 consists of six helical windings 100, but may consist of a different even number of helical windings 100. It may be desirable to have an even number of helical windings 110 in each group 100, in order to reduce circulation currents in the transformer core and reduce axial forces having compensated displacement due to the pitch on the ends of the helical windings 110. Each group 100 is connected in series to its adjacent group(s) 100. For example, group 100A is connected in series to group 100B, and group 100B is connected in series to group 100C. All of the groups 100 in plurality 500 of groups 100 may be configured to induce magnetic flux in the same direction along the longitudinal axis.

Each pair of adjacent groups 100 may share a cylinder 410. For example, cylinder 410B represents the outer cylinder of group 100A and the inner cylinder of group 100B. Similarly, cylinder 410C represents the outer cylinder of group 100B and the inner cylinder of group 100C. In addition, cylinder 410A represents the inner cylinder of group 100A, and cylinder 410D represents the outer cylinder of group 100C. As mentioned above, each cylinder 410 may comprise an insulating layer.

Since each group 100 comprises an even number of helical windings 110 and the connections between helical windings 110 alternate between ends E1 and E2 along longitudinal axis L, the entry (e.g., to the innermost helical winding 110) and exit (e.g., from the outermost helical winding 110) of each group 100 will be on the same end. For example, if the entry to group 100A is on end E1, the exit from group 100A will also be on end E1. Conversely, if the entry to group 100A is on end E2, the exit from group 100A will also be on end E2. Thus, each group 100 may be connected to its adjacent group(s) on the same end. For instance, group 100A may be connected in series to group 100B on end E1, and group 100B may be connected in series to group 100C on end E1.

As a result, the entry to plurality 500 of groups 100 will also be on the same end as the exit from plurality 500 of groups 100. For example, if the entry to plurality 500 is on end E1 to the innermost helical winding 110 of group 100A, the exit from plurality 500 will be on end E1 from the outermost helical winding 110 of group 100C. The entry and exit of plurality 500 do not need to be on the same end. However, having the entry and exit on the same end can be advantageous, since it facilitates the installation of the corresponding transformer terminals (e.g., LV terminals or HV terminals) on the same end of the transformer, which is typically desirable.

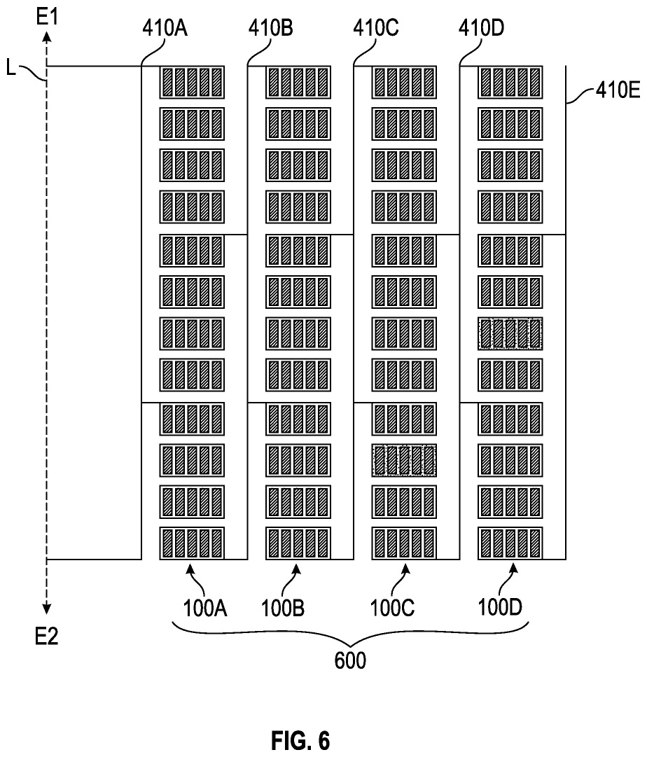

FIG. 6 illustrates a plurality 600 of concentrically arranged groups 100, in which each group 100 comprises an odd number of helical windings 110, according to an embodiment. In the illustrated example, each group 100 consists of five helical windings 100, but may consist of a different odd number of helical windings 100. Each group 100 is connected in series to its adjacent group(s) 100. For example, group 100A is connected in series to group 100B, group 100B is connected in series to group 100C, and group 100C is connected in series to group 100D. All of the groups 100 in plurality 600 of groups 100 may be configured to induce magnetic flux in the same direction along the longitudinal axis.

Since each group 100 comprises an odd number of helical windings 110 and the connections between helical windings 110 alternate between ends E1 and E2 along longitudinal axis L, the entry (e.g., to the innermost helical winding 110) and exit (e.g., from the outermost helical winding 110) of each group 100 will be on different ends. For example, if the entry to group 100A is on end E1, the exit from group 100A will be on end E2. Conversely, if the entry to group 100A is on end E2, the exit from group 100A will be on end E1. Thus, each group 100 may be connected to its adjacent group(s) on alternating ends. For instance, group 100A may be connected in series to group 100B on end E2, group 100B may be connected in series to group 100C on end E1, and group 100C may be connected to group 100D on end E2.

As a result, the entry to plurality 600 of groups 100 may or may not be on the same end as the exit from plurality 600 of groups 100, depending on the number of groups 100 in plurality 600 of groups 100. In particular, if the number of groups 100 is odd, the entry and exit will be on different ends. However, if the number of groups 100 is even, the entry and exit will be on the same end. For example, if the entry to plurality 600 is on end E1 to the innermost helical winding 110 of group 100A, the exit to plurality 600 will be on end E1 from the outermost helical winding 110 of group 100D, since there are an even number of groups 100, and therefore, an even number of total helical windings 100 across plurality 600. Again, the entry and exit of plurality 600 of groups 100 do not need to be on the same end. However, having the entry and exit on the same end can be advantageous, since it facilitates the installation of the corresponding transformer terminals (e.g., LV terminals or HV terminals) on the same end of the transformer, which is typically desirable. Thus, in an embodiment in which each group 100 has an odd number of helical windings 110, it may be desirable for plurality 600 to consist of an even number of groups 100.

### 3. Multiple Groups of Helical Windings Axially Separated

In an embodiment, a plurality of groups 100 of helical windings 110 may be axially separated and conductively connected in parallel. Each group 100 in the plurality of groups 100 may be concentric with the same longitudinal axis L. Any number of groups 100 may be axially separated in this manner. As mentioned above, the plurality of groups 100 may be used as the LV winding in a transformer or as the HV winding in a transformer. Furthermore, in a given transformer, both the LV winding and the HV winding may comprise a plurality of groups 100 arranged in this manner. It should be understood that each group 100 may be configured as described above, and may be essentially identical to each other, except that, in the illustrated embodiment, one group 100 may be the mirror image of another group 100 across a radial axis that bisects the axial distance between the two groups 100. In an embodiment, a group 100 may act as a failover apparatus to another group 100, such that, when the other group 100 experiences a fault or other failure, the transformer may switch (e.g., automatically, semi-automatically, or manually) to the group 100 acting as the failover apparatus. It has been found that these axially separated groups 100 exhibit good short-circuit behavior. All axially separated groups 100 may be configured to induce magnetic flux in the same direction along longitudinal axis L, or alternatively, one or more axially separated groups 100 may be configured to induce magnetic flux in an opposite direction along longitudinal axis L than one or more other axially separated groups 100.

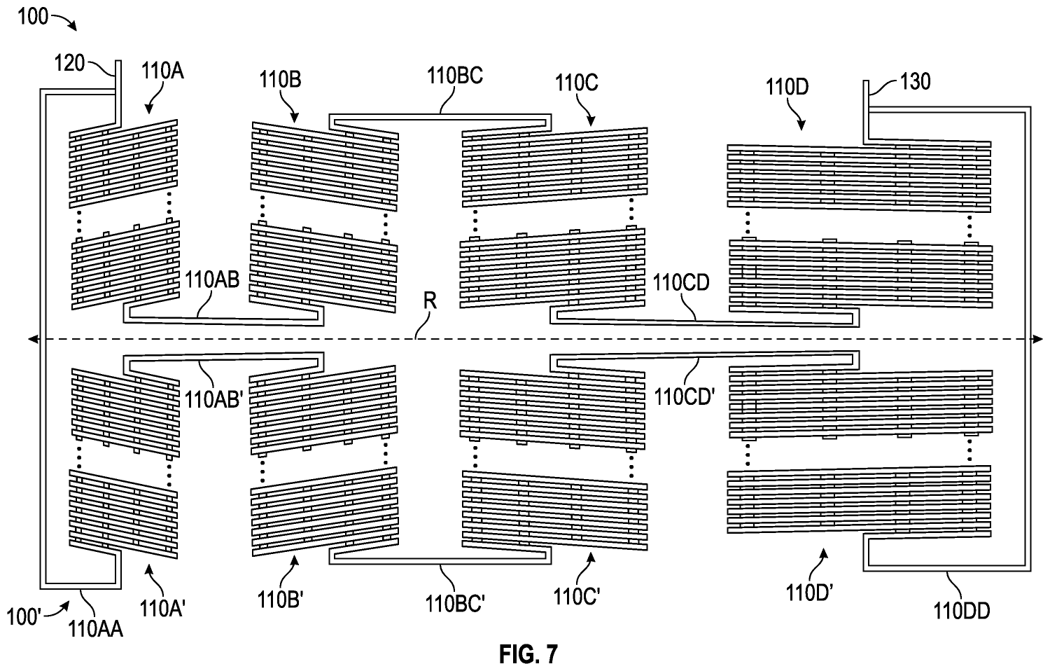

FIG. 7 illustrates an exploded side view of an axially separated pair of groups 100 of helical windings 110, according to an embodiment. Groups 100 and 100′ are mirrored across a radial axis R that bisects the space between the two groups 100 and 100′. Specifically, helical winding 110A′ is the mirror image of helical winding 110A, helical winding 110B′ is the mirror image of helical winding 110B, helical winding 110C′ is the mirror image of helical winding 110C, and helical winding 110D′ is the mirror image of helical winding 110D. In addition, connection 110AB′ is the mirror image of connection 110AB, connection 110BC′ is the mirror image of connection 110BC, and connection 110CD′ is the mirror image of connection 110CD. It should be understood that any description herein of one component applies equally to any component that is a mirror image of that component.

The pair of groups 100 and 100′ are conductively connected in parallel between leads 120 and 130 by an inner connection 110AA and an outer connection 110DD. In particular, inner connection 110AA connects the innermost helical winding 110A′ of group 100′ to inner lead 120, to which the innermost helical winding 110A of group 100 is also connected. Similarly, outer connection 110DD connects the outermost helical winding 110D′ of group 100′ to outer lead 130, to which the outermost helical winding 110D of group 100 is also connected. In an embodiment, inner connections 110AA and outer connection 110DD may be configured to be conductively connected and disconnected via a switch, such that group 100 may be operated alone or in combination with group 100′. In addition, the connection between the innermost helical winding 110A of group 100 may be configured to be conductively connected and disconnected via a switch, such that groups 100 and 100′ could be operated individually and independently or in combination in parallel. Leads 120 and 130 may be positioned on the same end of the apparatus comprising the pair of groups 100 and 100′, and/or the transformer's X1 and X2 terminals (e.g., conductively connected to leads 120 and 130, respectively) may be positioned on the same end of the transformer.

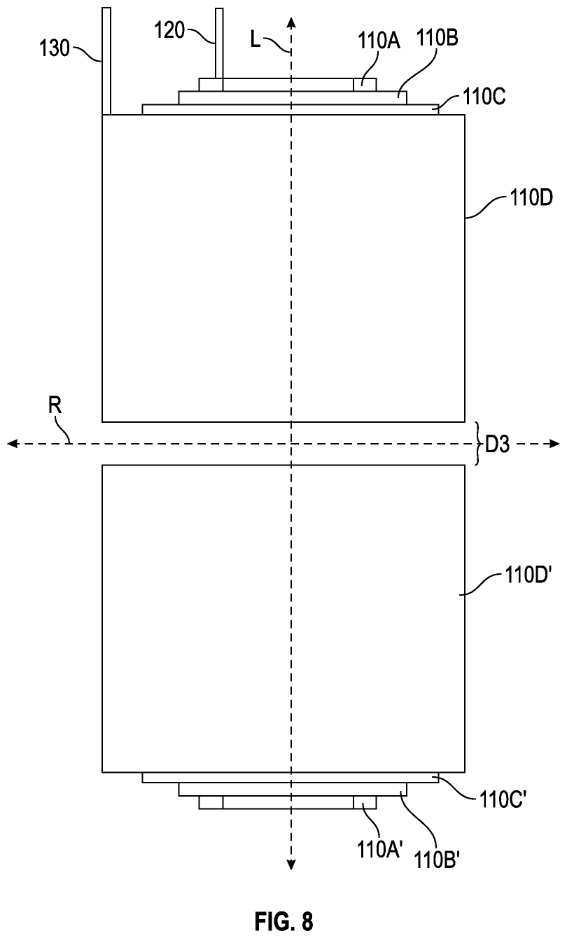

FIG. 8 illustrates a side profile view of an axially separated pair of groups 100 of helical windings 110, according to an embodiment. For case of illustration, the plurality of turns 112 in each helical winding 110 are not individually depicted. In addition, the height of each helical winding 110, along longitudinal axis L, has been varied to show the different layers. In an alternative embodiment, the heights of each helical winding 110, along longitudinal axis L, may be identical or may be varied in a different manner based on dielectric testing.

Notably, group 100′ is axially separated from group 100 by a non-zero axial distance D3 along the longitudinal axis. In addition, group 100′ mirrors group 100 across a radial axis R that bisects axial distance D3. In an embodiment, an insulation layer (not shown) may be mounted in the space between groups 100 and 100′ that is created by axial distance D3. This insulation layer may be coextensive with the cross-sectional profiles of groups 100 and 100′, orthogonal to longitudinal axis L, so as to isolate group 100 from group 100′ and prevent electrical conduction between groups 100 and 100′.

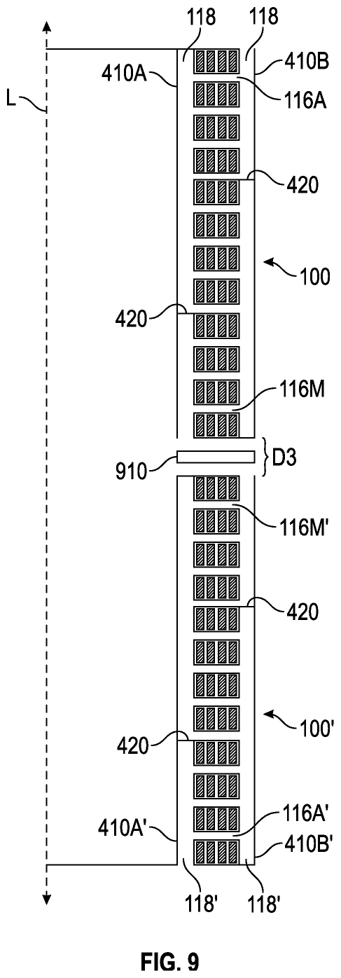

FIG. 9 illustrates a cross-sectional view of half of an axially separated pair of groups 100 of helical windings 110, according to an embodiment. The pair of groups 100 and 100′ are separated by an insulation layer 910. Each group 100 and 100′ may encircle separate cylinders 410A and 410A′, respectively, and be encircled by separate cylinders 410B and 410B′, respectively. Alternatively, both groups 100 and 100′ may encircle the same cylinder 410 and/or be encircled by the same cylinder 410. Each of groups 100 and 100′ may comprise radial space(s) 116, axial space(s) 118, and/or liquid guides 420 for cooling, as previously described.

### 4. Multiple Groups of Helical Windings Radially Arranged and Axially Separated

In an embodiment, a first plurality of groups 100 of helical windings 110 may be nested within each other, along a radial axis, and conductively connected in series, and a second plurality of groups 100 of helical windings 110 may also be nested within each other, along a radial axis, and conductively connected in series. The first plurality of groups 100 may be axially separated from the second plurality of groups 100 by an axial distance D3 in a direction that is parallel to the longitudinal axis. The second plurality of groups 100 may be a mirror image of the first plurality of groups 100 across a radial axis that bisects the axial distance D3. An insulation layer 910 may be provided between the first plurality of groups 100 and the second plurality of groups 100 to electrically isolate the two pluralities of groups 100.

The first and second pluralities of groups 100 may be used, collectively, as the LV winding in a transformer or as the HV winding in a transformer. Furthermore, in a given transformer, each of the LV winding and the HV winding may comprise first and second pluralities of groups 100 arranged collectively in this manner. It should be understood that each group 100 may be configured as described above, and may be essentially identical to each other, except in terms of their respective radii and related characteristics, which will differ within a given plurality, and the mirroring across the radial axis.

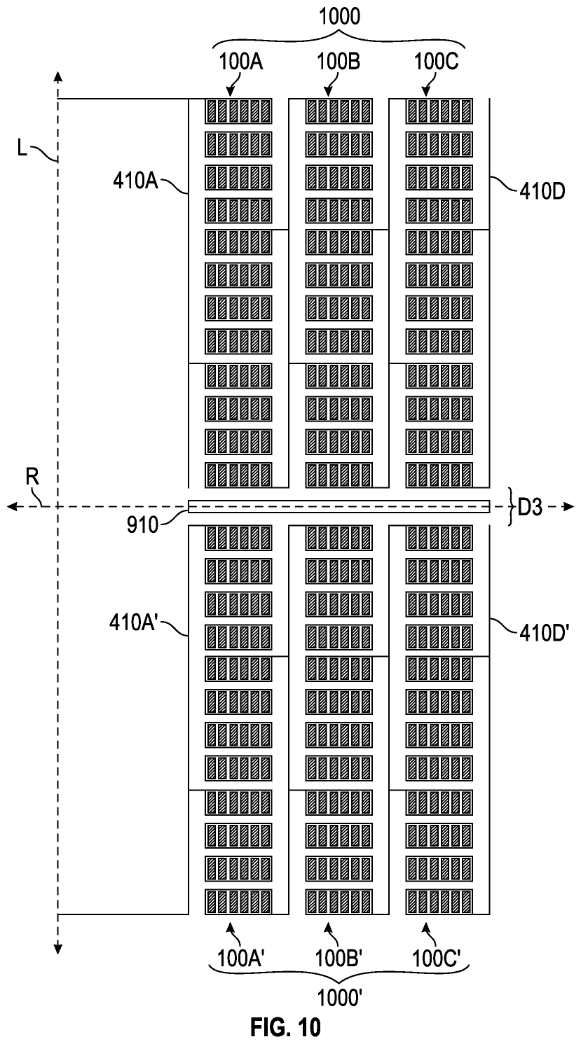

FIG. 10 illustrates a cross-sectional view of half of axially separated pluralities of radially arranged groups 100 of helical windings 110, in a cross-sectional plane that contains longitudinal axis L, according to an embodiment. As illustrated, a first plurality 1000 of nested groups 100A, 100B, and 100C are concentrically arranged around longitudinal axis L. In addition, a second plurality 1000′ of nested groups 100A′, 100B′, and 100C′ are concentrically arranged around longitudinal axis L. While each of pluralities 1000 and 1000′ are illustrated with three groups 100, each of pluralities 1000 and 1000′ may be implemented with any number of groups 100. It is generally contemplated that both of pluralities 1000 and 1000′ would have the same number of groups 100, but this is not a requirement of any embodiment. In addition, if each group 100 has an odd number of helical windings 110 and it is desired to have the entry and exit to each plurality 1000 and 1000′ on a same end of the apparatus, each plurality 1000 and 1000′ should have an even number of groups 100. It can also be desirable to have an even number of helical windings 110 across groups 100, in order to reduce circulation currents in the transformer core and reduce axial forces, having compensated displacement due to the pitch on the ends of the helical windings 110 and the low spiraling effect.

Second plurality 1000′ is axially separated from first plurality 1000 by an axial distance D3 in a direction that is parallel to the longitudinal axis. In addition second plurality 1000′ is a mirror image of first plurality 1000 across a radial axis R that bisects the axial distance D3. Insulation layer 910 may be mounted within the radial space formed by axial distance D3 to electrically isolate first plurality 1000 from second plurality 1000′.

In an embodiment, cylinders 410 may partition each group 100 from each other and the transformer core, as well as other windings. For example, in the illustrated embodiment, inner cylinder 410A partitions the innermost group 100A of first plurality 1000 from the transformer core. In addition, outer cylinder 410D partitions the outermost group 100C of first plurality 1000 from a radially outward exterior of first plurality 1000, which may comprise additional windings (e.g., HV windings in an identical, similar, or different configuration). Additional internal cylinders 410 may partition group 100B from groups 100A and 100C. Similarly, inner cylinder 410A′ partitions the innermost group 100A′ of second plurality 1000′ from the transformer core, outer cylinder 410D′ partitions the outermost group 100C′ of second plurality 1000′ from a radially outward exterior of second plurality 1000′, which may comprise additional windings, and additional internal cylinders 410 may partition group 100B′ from groups 100A′ and 100C′. While cylinder 410A is illustrated as separate from cylinder 410A′, in an alternative embodiment, cylinders 410A and 410A′ may be combined into a single continuous cylinder 410. Similarly, cylinders 410D and 410D′ may be combined into a single continuous cylinder 410. In these cases, the internal cylinders 410 for first plurality 1000 may remain separate from cylinders 410 for second plurality 1000′, with insulation layer 910 between the separated internal cylinders 410. Alternatively, one or more, including potentially all, of the internal cylinders 410 may be single continuous cylinders 410 that extend axially through both first plurality 1000 and second plurality 1000′ of groups 100.

### 5. Transformer

Whether as a single group 100, a plurality of radially arranged groups 100, a plurality of axially separated groups 100, or a plurality of radially arranged and axially separated groups 100, the disclosed configurations of helical windings 110 may be used as the LV winding and/or HV winding in any type of transformer, including, for example, single-phase or three-phase distribution transformers, dry transformers, and power transformers. A transformer may utilize one of the configurations for the LV winding and a different one of the configurations for the HV winding, may utilize the same configuration for each of the LV winding and the HV winding, or may utilize one of the configurations for one of the LV winding or HV winding and utilize a conventional configuration for the other one of the LV winding and HV winding. It should be understood that although the configurations may be the same for LV windings and HV windings, the number of turns 112 will typically vary between LV windings and HV windings. In particular, the number of turns 112 used for an HV winding will typically be higher than the number of turns 112 used for an LV winding.

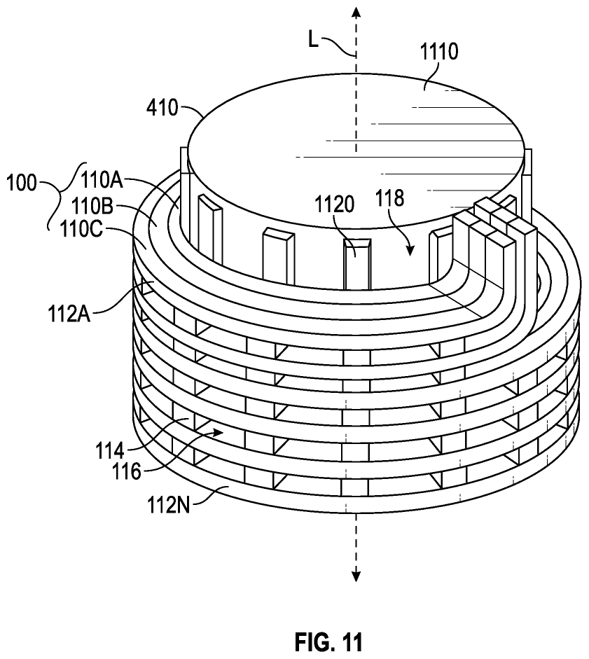

FIG. 11 illustrates a perspective view of a limb of a transformer core encircled by a single group 100 of helical windings 110, according to an embodiment. Limb 1110 is concentric with longitudinal axis L of group 100, which consists of three helical windings 110A, 110B, and 110C. In the illustrated example, each helical winding 110A, 110B, and 100C comprises two axially separated cables (e.g., separated by spacers 114), such that group 100 collectively comprises 2×3 cables. Limb 1110 is encircled by a cylinder 410, which may comprise an insulating layer that insulates limb 1110 from group 100. In addition, a plurality of axial spacers 1120 extend along the radially outward surface of cylinder 410, parallel to longitudinal axis L. The spaces between axial spacers 1120 form axial spaces 118, which may act as ducts for coolant, as described elsewhere herein. Similarly, a plurality of spacers 114 separate each of turns 112A-112N in each of helical windings 110A-110C. Spacers 114 may be mounted at equidistant intervals along each winding. The spaces between spacers 114 form radial spaces 116, which may act as ducts for coolant, as described elsewhere herein.

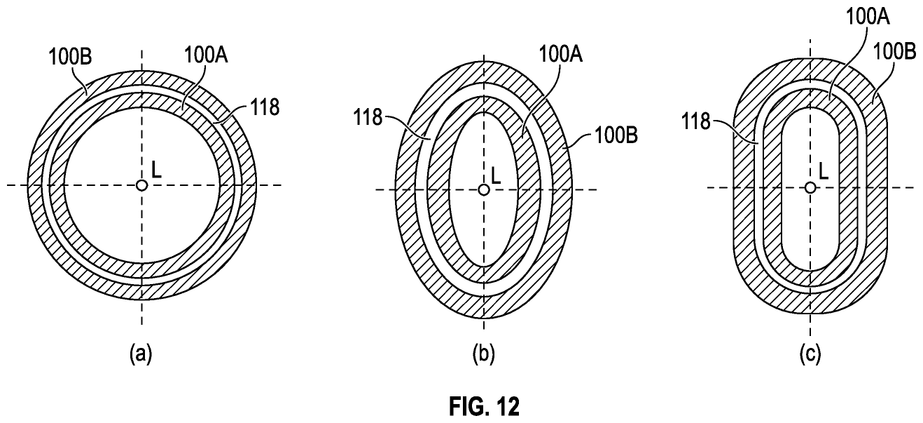

FIG. 12 illustrates cross-sectional profiles of groups 100 of helical windings 110, in a cross-sectional plane that is substantially orthogonal to longitudinal axis L, according to various embodiments. For example, as illustrated in profile (a), groups 100 (e.g., 100A and 100B) may have circular profiles. However, other profiles are possible, such as an elliptical profile (b), a stadium profile (c), as well as others (e.g., square, rectangular, triangular, diamond, etc.). Thus, as used herein, the terms “radius,” “radial,” “diameter,” “cylinder,” “encircle,” and the like, should not be construed as requiring a circular profile. Rather, the disclosed embodiments may be easily adapted to any cross-sectional profile. In addition, it should be understood that the cross-sectional profile of each cylinder 410 and/or limb 1110 of a transformer core may match the cross-sectional profile selected for group(s) 100, and vice versa.

A typical transformer core comprises one or more limbs 1110 extending between a pair of yokes. The limbs 1110 in a transformer core may comprise at least one main limb and zero, one, or more side limbs. A main limb carries the windings, whereas the side limbs act as return paths connecting the yokes. Accordingly, it should be understood that any of the disclosed configurations of one or a plurality of groups 100 of helical windings 110 may be implemented around one or more main limbs in a transformer core as the LV winding, the HV winding, or each of the LV and HV windings. It should also be understood that each limb 1110 of a transformer core has its own longitudinal axis L around which group(s) 100 of the LV and HV windings are concentric.

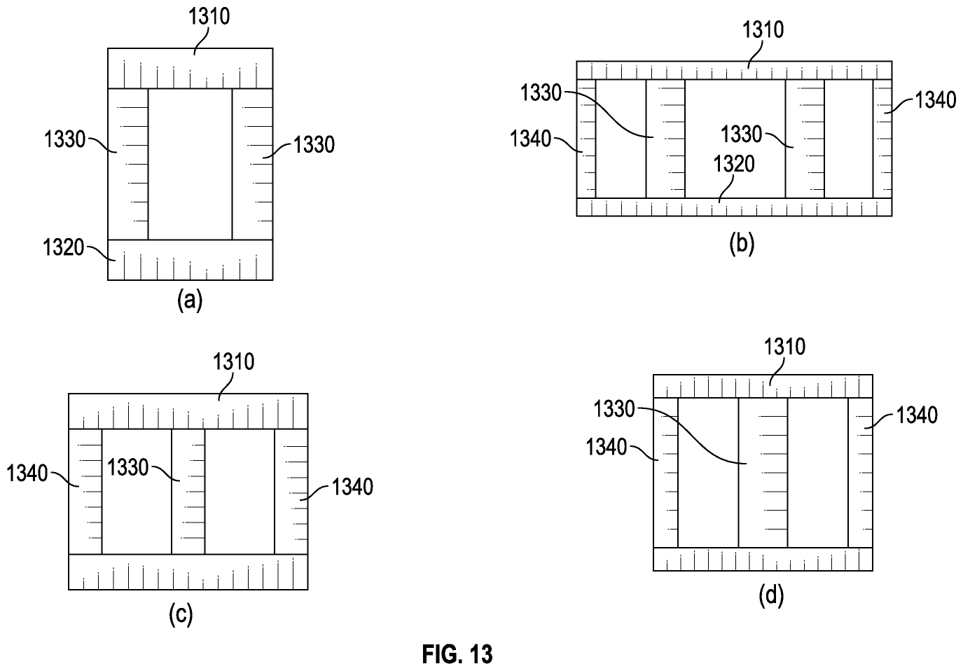

FIG. 13 illustrates a single-phase transformer core, according to various embodiments. Each single-phase transformer core comprises a first yoke 1310, a second yoke 1320, and at least one main limb 1330 extending between first yoke 1310 and second yoke 1320. In addition, a single-phase transformer core may comprise one or more side limbs 1340 extending between first yoke 1310 and second yoke 1320. For example, in FIG. 13, transformer core (a) comprises two main limbs 1330 and no side limbs, transformer core (b) comprises two main limbs 1330 and two side limbs 1340, transformer core (c) comprises two main limbs 1330 and one side limb 1340, and transformer core (d) comprises one main limb 1330 and two side limbs 1340.

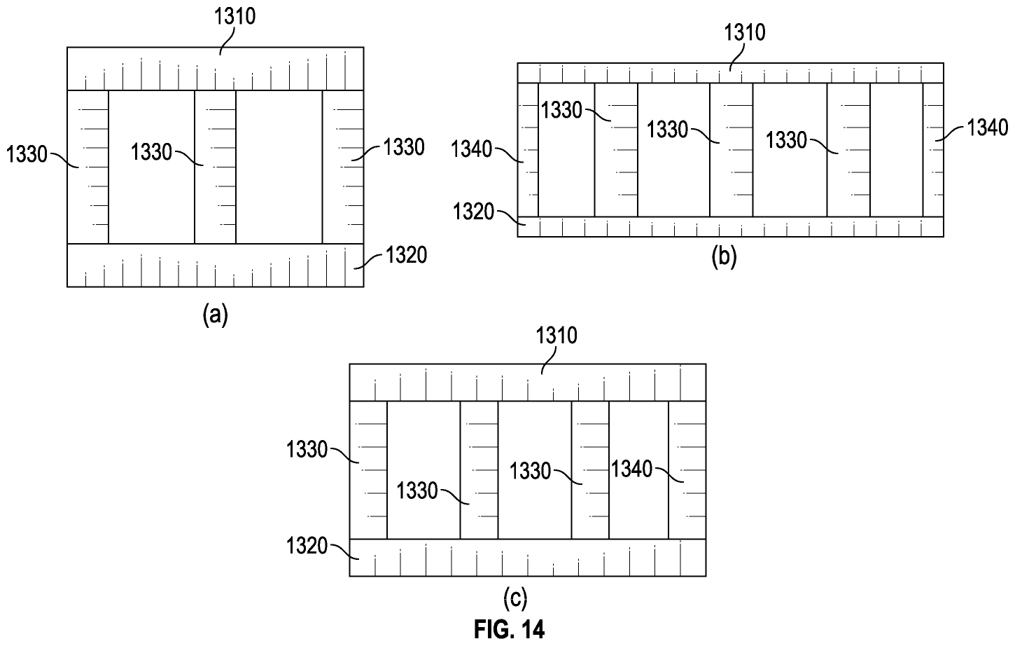

FIG. 14 illustrates a three-phase transformer, according to various embodiments. Each three-phase transformer comprises a first yoke 1310, a second yoke 1320, and three main limbs 1330 extending between first yoke 1310 and second yoke 1320. In addition, a three-phase transformer may comprise one or more side limbs 1340 extending between first yoke 1310 and second yoke 1320. For example, in FIG. 14, transformer core (a) comprises three main limbs 1330 and no side limbs, transformer core (b) comprises three main limbs 1330 and two side limbs 1340, and transformer core (c) comprises three main limbs 1330 and one side limb 1340.

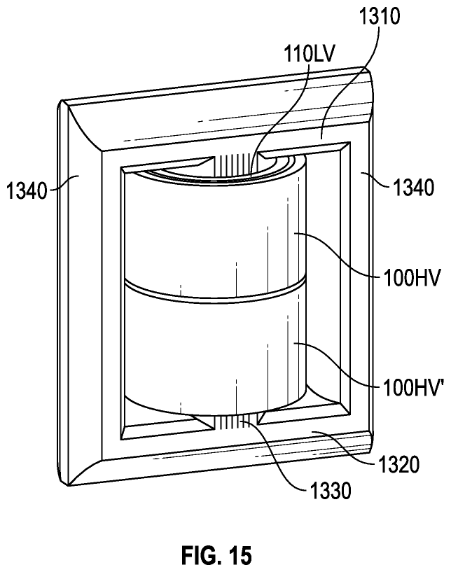

FIG. 15 illustrates a perspective view of a transformer core, according to an embodiment. The transformer core comprises a single main limb 1330 and two side limbs 1340, extending between a first yoke 1310 and second yoke 1320. The HV winding around main limb 1330 comprises an axially separated pair of groups 100, comprising group 100HV and a mirrored group 100HV′. Similarly, the LV winding around main limb 1330 comprises an axially separated pair of groups 100, comprising group 100LV and a mirrored group 100 which is hidden by group 100HV′. The LV and HV windings are both concentric around the longitudinal axis of main limb 1330, with the LV winding having a smaller radius and being encircled by the HV winding, such that the LV winding is closer to main limb 1330 than the HV winding.

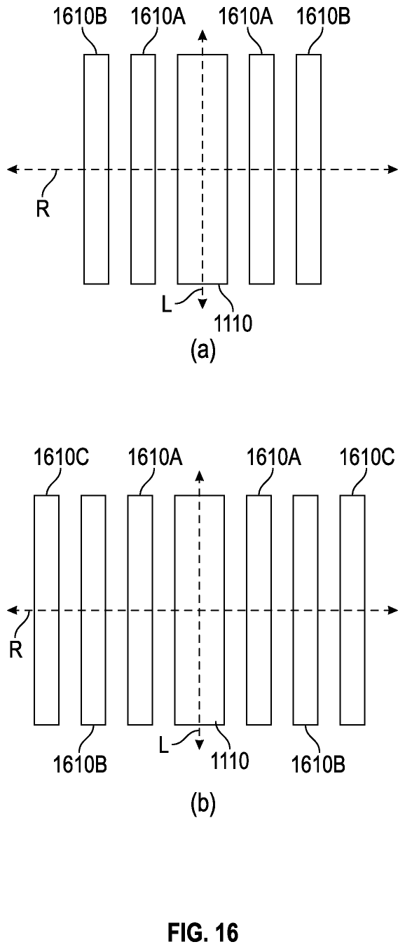

FIG. 16 illustrates a cross-sectional profile view of a plurality of windings around a limb of a transformer core, in a cross-sectional plane that contains longitudinal axis L, according to two embodiments. In particular, a plurality of windings 1610 (e.g., 1610A, 1610B, and/or 1610C) encircle a limb 1110 of the transformer core. Each of the plurality of windings 1610 may comprise one or a plurality of groups 100 in any of the configurations described herein. In example (a), two windings 1610A and 1610B encircle limb 1110, with winding 1610A nested within winding 1610B along radial axis R. Winding 1610A may be the LV winding of the transformer, and winding 1610B may be the HV winding of the transformer. In example (b), three windings 1610A, 1610B, and 1610C encircle limb 1110, with winding 1610A nested within winding 1610B along radial axis R, and winding 1610B nested within winding 1610C along radial axis R. In this case, winding 1610A may be a tertiary winding, winding 1610B may be the LV winding, and winding 1610C may be the HV winding of the transformer.

### 6. Examples of Industrial Applicability

The utilization of one or more of the disclosed configurations of windings in a transformer may provide a number of advantages. For example, by reducing the height and/or radial dimensions of the windings (e.g., by adjusting the dimensions and/or numbers of groups 100), the mass of the transformer core can be reduced while maintaining the same effective core area, core flux density, and/or transformer rated power. A reduction in the winding and core volumes can result in a more compact active part and reduce the dimensions of the transformer tank, thereby permitting a reduction in the dimensions of the transformer itself, as well as reduce the material costs and the overall transformer cost relative to a conventional transformer.

The disclosed configurations of windings also permit the circulation of higher currents in the LV windings of transformers and increase the rated power and the permissible current and/or voltage of the transformer.

The disclosed configurations of windings can also be used to reduce core circulation currents, since the currents in helical windings 110 of a group 100 circulate in opposite directions.

The disclosed configurations of windings can also be used to reduce axial forces. For example, a spiraling effect occurs in helical windings 110 that are subjected to compressive stress. The spiraling effect is the tendency of a helical winding 110 to tighten around the component that the helical winding 110 encircles (e.g., cylinder 410 or an adjacent helical winding 110) by twisting itself towards a winding with a smaller diameter and higher pitch. This spiraling effect can be reduced by reducing the tangential force under the maximum admissible limit, for example, by reducing the tangential stress and the conductor area. The tangential stress and conductor area can be reduced by reducing the current circulating in the conductor. Thus, the axially separated pair of groups 100 of helical windings 110 reduces axial forces by halving the conductor area and reducing the tangential stress by halving the current circulating in the conductor. This permits the axially separated pair of groups 100 to have higher current with lower spiraling effect.

The disclosed configurations of windings with radial spaces 116 and/or axial spaces 118 (e.g., implemented by spacers 114 and/or 1120) can also provide improved cooling by increasing the total area of dissipation surfaces. In turn, this allows a significant increase in the current density within the transformer.

The above description of the various disclosed embodiments is provided to enable any person skilled in the art to make or use the various embodiments disclosed. Various modifications to these embodiments will be readily apparent to those skilled in the art, and the general principles described herein can be applied to other embodiments. Thus, it is to be understood that the description and drawings presented herein represent embodiments, and therefore, are merely representative of the subject matter which is broadly contemplated. It is to be further understood that the scope of the present disclosure fully encompasses other embodiments that may become obvious to those skilled in the art and that the scope of the present disclosure is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

1-15. (canceled)

16. An apparatus comprising:
a group of helical windings configured to be concentrically arranged around a transformer core and concentrically arranged around a longitudinal axis to induce magnetic flux in a same direction along the longitudinal axis,
at least one helical winding in the group being conductively connected in series to an adjacent helical winding and has a different inner radial distance from the longitudinal axis than the adjacent helical winding,
the group having two opposing ends along the longitudinal axis,
in the group, at least one internal one of the helical windings having an inner connection with an adjacent radially inward one of the helical windings and an outer connection with an adjacent radially outward one of the helical windings, and
the inner connection being on a different one of the two opposing ends than the outer connection.

17. The apparatus of claim 16, wherein at least one helical winding in the group comprises a plurality of turns, and at least one of the plurality of turns is separated from an axially adjacent turn in the plurality of turns by an axial distance in an axial direction that is parallel to the longitudinal axis.

18. The apparatus of claim 17, wherein each of the helical windings in the group comprises a plurality of turns, radially aligned to form at least one radially extending space through all of the helical windings in a radial direction that is orthogonal to the longitudinal axis.

19. The apparatus of claim 18, further comprising at least one liquid guide that extends in the radial direction through at least a portion of the at least one radially extending space.

20. The apparatus of claim 16, further comprising an insulating layer that is encircled by the group and is concentric with the group around the longitudinal axis, wherein an innermost one of the helical windings in the group directly contacts the insulating layer.

21. The apparatus of claim 16, further comprising an insulating layer that is encircled by the group and is concentric with the group around the longitudinal axis, wherein an innermost one of the helical windings in the group is separated from the insulating layer by a radial distance in a radial direction, which is orthogonal to the longitudinal axis, to form one or more axially extending spaces between the insulating layer and the innermost helical winding.

22. The apparatus of claim 16, further comprising:
a first terminal conductively connected to an electrical lead of a radially inner one of the helical windings in the group; and
a second terminal conductively connected to an electrical lead of a radially outer one of the helical windings in the group,
wherein the second terminal is on a same end of the apparatus as the first terminal.

23. The apparatus of claim 16, comprising two groups of helical windings, wherein
a first one of the two groups is connected in parallel with a second one of the two groups,
the first group and the second group have a same inner radial distance from the longitudinal axis, and
the first group is separated from the second group by an axial distance in an axial direction that is parallel to the longitudinal axis.

24. The apparatus of claim 23, wherein the second group mirrors the first group across a radial axis that is orthogonal to the longitudinal axis and bisects the axial distance.

25. The apparatus of claim 23, further comprising:
a first terminal conductively connected to an electrical lead of an inner one of the helical windings in the first group and an electrical lead of an inner one of the helical windings in the second group; and
a second terminal conductively connected to an electrical lead of an outer one of the helical windings in the first group and an electrical lead of an outer one of the helical windings in the second group,
wherein the second terminal is on a same end of the apparatus as the first terminal.

26. The apparatus of claim 16, comprising a plurality of groups of helical windings, wherein the plurality of groups are concentric to each other around the longitudinal axis, and at least one of the plurality of groups is conductively connected in series to an adjacent one of the plurality of groups, and has a different inner radial distance from the longitudinal axis than the adjacent group.

27. The apparatus of claim 26, wherein, for at least one adjacent pair of the plurality of groups, comprising a radially inner group and a radially outer group, an outermost one of the helical windings in the inner group is separated from an innermost one of the helical windings in the outer group by a radial distance in a radial direction, which is orthogonal to the longitudinal axis, to form one or more axially extending spaces between the outermost helical winding in the inner group and the innermost helical winding in the outer group.

28. The apparatus of claim 26, wherein
each of the plurality of groups consists of an odd number of helical windings, and
each internal one of the plurality of groups having an inner connection to an adjacent radially inward one of the plurality of groups and an outer connection to an adjacent radially outward one of the plurality of groups, and the inner connection is located on a same end of the apparatus as the outer connection.

29. The apparatus of claim 26, wherein
each of the plurality of groups consists of an even number of helical windings, and
each internal one of the plurality of groups having an inner connection to an adjacent radially inward one of the plurality of groups and an outer connection to an adjacent radially outward one of the plurality of groups, and the inner connection is located on a different end of the apparatus than the outer connection.

30. An apparatus comprising:
a group of helical windings configured to be concentrically arranged around a transformer core and concentrically arranged around a longitudinal axis to induce magnetic flux in a same direction along the longitudinal axis,
at least one helical winding in the group being conductively connected in series to an adjacent helical winding and has a different inner radial distance from the longitudinal axis than the adjacent helical winding,
the group of helical windings comprising:
a first group of helical windings connected in parallel with a second group of helical windings,
the first group and the second group having a same inner radial distance from the longitudinal axis, and
the first group being separated from the second group by an axial distance in an axial direction that is parallel to the longitudinal axis.

31. The apparatus of claim 30, wherein at least one helical winding in the group comprises a plurality of turns, and at least one of the plurality of turns is separated from an axially adjacent turn in the plurality of turns by an axial distance in an axial direction that is parallel to the longitudinal axis.

32. The apparatus of claim 30, wherein each of the helical windings in the group comprises a plurality of turns, radially aligned to form at least one radially extending space through all of the helical windings in a radial direction that is orthogonal to the longitudinal axis.

33. The apparatus of claim 32, further comprising at least one liquid guide that extends in the radial direction through at least a portion of the at least one radially extending space.

34. The apparatus of claim 30, wherein
the group has two opposing ends along the longitudinal axis,
in the group, at least one internal one of the helical windings has an inner connection with an adjacent radially inward one of the helical windings and an outer connection with an adjacent radially outward one of the helical windings, and
the inner connection is on a different one of the two opposing ends than the outer connection.

35. The apparatus of claim 30, further comprising an insulating layer that is encircled by the group and is concentric with the group around the longitudinal axis, wherein an innermost one of the helical windings in the group directly contacts the insulating layer.
